(19) United States
(12) Patent Application Publication
(10) Pub. No.: US 2006/0167625 A1
(43) Pub. Date: Jul. 27, 2006

(54) Method for finding path in a navigation system

(75) Inventors: Sang-Yoon Jung, Yongin-si (KR); Yong-Ik Choi, Suwon-si (KR); Young-Khon Moon, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/333,850

(22) Filed: Jan. 18, 2006

(30) Foreign Application Priority Data
Jan. 25, 2005 (KR) 2005-6777

(51) Int. Cl. G01C 21/30

(52) U.S. Cl. 701/209; 701/211

(57) ABSTRACT

Disclosed is a method for finding a path in a navigation system. The method includes selecting a sectional path option for a specific section selected by a user from an entire section between a start point and an end point, and finding a path in the specific section according to the sectional path option and creating an entire path for an entire section by employing the path in the specific section. Accordingly, a sectional path option different from an entire path operation for an entire path is applied to a specific section desired by a user on an entire path to an end point from a start point, so that it is possible to efficiently apply an option desired by the user to path finding.

### PRIORITY

This application claims priority to an application entitled “Method for Finding Path in Navigation System” filed in the Korean Intellectual Property Office on Jan. 25, 2005 and assigned Serial No. 2005-6777, the contents of which are incorporated herein by reference.

### BACKGROUND OF THE INVENTION

1. Field of the Invention

The present invention relates to a navigation system, and more particularly to a method for finding a path from a start point to an end point (destination) in a navigation system.

2. Description of the Related Art

Generally, navigation systems have a function of setting a user option such that the navigation system can find a path to an end point desired by the user when performing path finding.

The user option may include various path finding preferences such as “expressway preference”, “the shortest way”, and “free-toll road preference”, and the user can select a desired option from among predetermined user options so as to find an ideal path (i.e. the shortest or most efficient path) to an end point.

FIG. 1 is a view of a concept of the conventional path finding method. Referring to FIG. 1, conventionally, a user inputs a desired end point in a navigation system and selects an option for an entire path to the end point (e.g., “Option 1”). Then, the navigation system finds a path to the end point from a start point by employing “Option 1”, which is selected by the user, for the entire path to the end point from the start point and then guides the user.

Accordingly, according to the conventional path finding method described above, since an option, which is selected by a user one time, is applied to the entire path, the navigation system finds a path to an end point through only a single option and then guides the user.

Therefore, the conventional method cannot satisfy a user if the user wants to receive guidance with respect to a different option in relation to a partial section of the entire path.

### SUMMARY OF THE INVENTION

Accordingly, the present invention has been made to solve the above-mentioned problems occurring in the prior art, and an object of the present invention is to provide an apparatus and a method for finding a path in a navigation system, which find an entire path to an end point by applying a different path option desired by a user to a partial section of the entire path.

Another object of the present invention is to provide an apparatus and a method for finding a path in a navigation system, which find an entire path to an end point by setting an option desired by a user according to sections of the entire path and applying each set option to each section.

To accomplish the above objects, there is provided a method for finding a path in a navigation system, the method including selecting a sectional path option for a specific section selected by a user from an entire section between a start point and an end point, and finding a path in the specific section according to the sectional path option and creating an entire path for an entire section by employing the path in the specific section.

According to another aspect of the present invention, there is provided a method for finding a path in a navigation system, the method including finding an entire path using an entire path option for an entire section between a start point and an end point, selecting a specific section desired by a user on the found entire path, selecting a sectional path option for the selected specific section according to user demand, re-finding a path for the specific section by employing the selected sectional path option, and creating the entire path by replacing a path for the specific section on the entire path with the re-found path for the specific section.

According to still another aspect of the present invention, there is provided a method for finding a path in a navigation system, the method including selecting an entire path option for an entire section between a start point and an end point, selecting a sectional path option for a specific section in the entire section, finding a path for each section according to the entire path option and the sectional path option, and creating an entire path using the found path for each section.

### BRIEF DESCRIPTION OF THE DRAWINGS

The above and other objects, features and advantages of the present invention will be more apparent from the following detailed description taken in conjunction with the accompanying drawings, in which:

FIG. 1 is a view of a concept of the conventional path finding method;

FIG. 2 is a block diagram illustrating the structure of a path finding apparatus according to an embodiment of the present invention;

FIGS. 3(A) to 3(C) are views of the concept of a path finding method according to a first embodiment of the present invention;

FIG. 4 is a flowchart illustrating a procedure of finding a path according to the first embodiment of the present invention;

FIG. 5 illustrates a map image showing a specific section selected by a user according to a first embodiment of the present invention;

FIG. 6 illustrates a map image showing a re-found path for a specific section selected by a user from an entire path according to a first embodiment of the present invention;

FIG. 7 illustrates a map image of an entire path re-found using a specific section according to the first embodiment of the present invention;

FIG. 8 is a view of the concept of a path finding method according to a second embodiment of the present invention;

FIG. 9 is a flowchart illustrating the procedure of finding a path according to a second embodiment of the present invention; and

FIGS. 10(A) and 10(B) illustrate an example of the map image according to the second embodiment of the present invention.

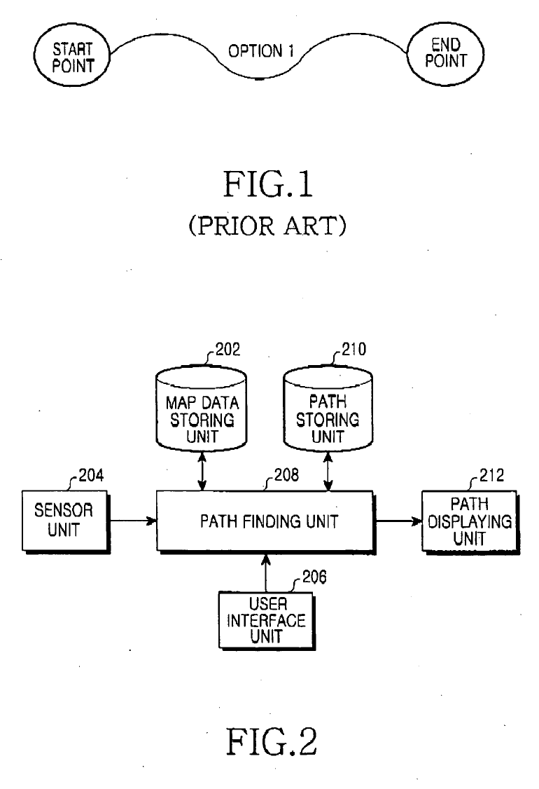

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

FIG. 2 is a block diagram illustrating the structure of a path finding apparatus according to an embodiment of the present invention. The path finding apparatus according to an embodiment of the present invention includes a map data storing unit 202, a sensor unit 204, a user interface unit 206, a path finding unit 208, a path storing unit 210, and a path displaying unit 212.

The map data storing unit 202 stores map data for roads, buildings, and facilities. The sensor unit 204 is a device for measuring the current position of a vehicle, and the sensor unit 204 includes a Global Positioning System (GPS) sensor and a dead reckoning (DR) sensor. The GPS sensor receives a GPS signal and detects position information (x, y, z) and time information (t) of a moving vehicle using the GPS signal. The DR sensor can recognize a relative position and a progress direction of the moving member using previous position information and detect a velocity (v) and an angle (θ) of the moving member. The sensor unit 204 detects the current position of a vehicle by using the position information (x, y, z) and the time information (t) of the vehicle obtained through the GPS sensor and a velocity (v) and an angle (θ) of the vehicle obtained through the DR sensor.

The user interface unit 206 includes input devices such as a key pad and a touch panel and interfaces a user with a navigation system. The user interface unit 206 receives a start point/end point or an intermediate point by a user, or receives a specific section of a path and a specific option for the section, which are selected by the user, thereby outputting an input signal and a selection signal according to the received information to the path finding unit 208.

The path finding unit 208 finds a path between a start point and an end point by using an entire path option applied to an entire section on the path between the start point and the end point, or a sectional path option applied to a specific section in the entire section.

The path storing unit 210 stores paths found by the path finding unit 208. The path displaying unit 212 displays paths found by the path finding unit 208 on a map screen using the map data.

Hereinafter, a path finding method in a path finding apparatus having the structure described above according to an embodiment of the present invention will be described.

According to a first embodiment of the present invention, the path finding apparatus finds a route from a start point to an end point by employing the option for the entire path, and then receives a partial section of the entire path and a sectional path option applied to the partial section from a user, thereby creating an entire path.

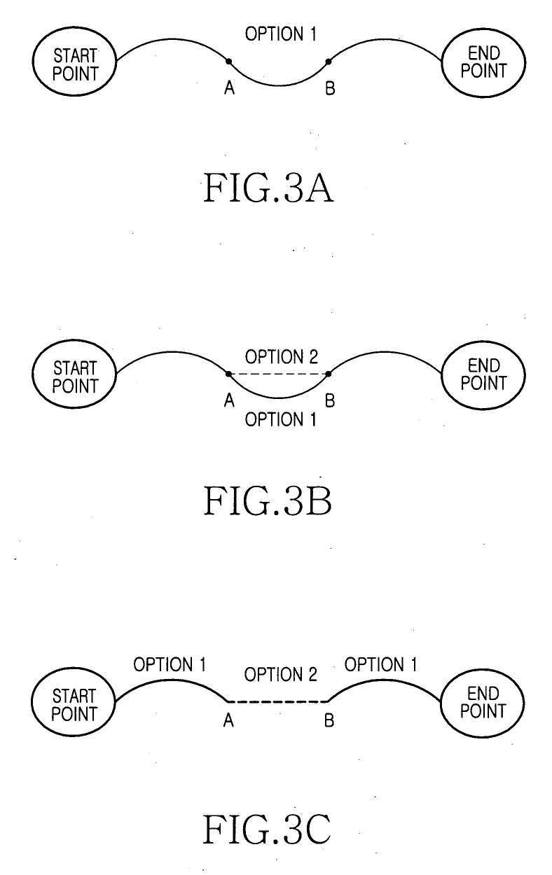

FIGS. 3(A) to 3(C) are views of the concept of the path finding method according to the first embodiment of the present invention. If a start point/end point are input, and “Option 1” is input, the path finding apparatus finds an entire path to the end point from the start point by applying “Option 1” to the entire path as shown in FIG. 3(A).

In addition, the path finding apparatus receives a predetermined section selected by a user from the entire path, which undergoes another option. FIG. 3(A) illustrates a case in which the section selected by the user is a section A to B. The user may select an unsatisfactory section or a section undergoing another option from the entire path.

The path finding apparatus having received a section selected from the entire path as described above receives an option selected by the user to be applied to the selected section. In other words, an option different from “Option 1” applied to the entire path, can be input to the path finding apparatus which receives an option to be applied to a section A to B which is the section selected from the entire path. FIG. 3(B) is a view illustrating a case in which the option to be applied to the section A to B selected from the entire path is selected as “Option 2”.

If the option for the section A to B selected from the entire path is selected as “Option 2” as described above, the path finding apparatus re-finds a path for the section A to B by employing “Option 2”. Then, the path finding apparatus finds an entire path by replacing a path for the section A to B with the path for the section A to B re-found by employing “Option 2” as shown in FIG. 3(C).

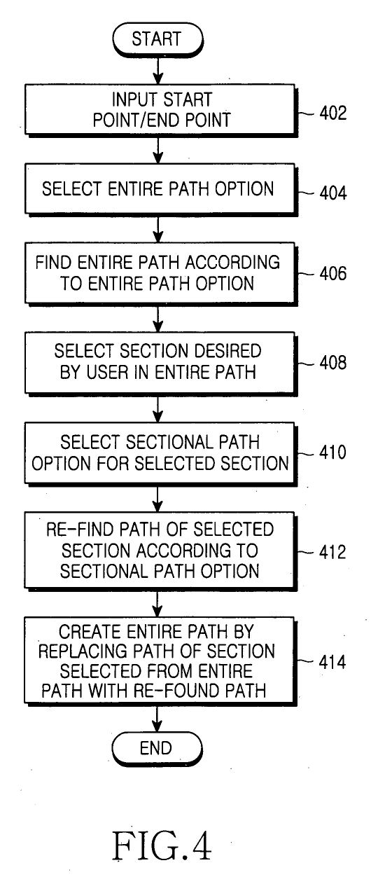

Hereinafter, a procedure of performing a path finding method according to the first embodiment of the present invention as described above will be described with reference to the flow chart of FIG. 4. The path finding apparatus receives a start point/end point in step 402. At this time, the path finding apparatus receives the start point/end point from a user through the user interface unit 206. Herein, the start point may be a current point measured by the sensor unit 204 as well as a start point input by the user. If the start point/end point are input as described above, the path finding apparatus selects an option applied to an entire path in step 404. In other words, according to a selection signal of the user, the path finding apparatus selects an entire path option to be applied to the entire path when finding a path to the end point from the start point. In addition, the path finding apparatus finds an entire path according to the entire path option selected in step 406. In other words, the path finding apparatus finds the entire path by using the entire path option selected by the user for finding the entire path of the end point from the start point. At this time, the found entire path may be displayed through the path displaying unit 212.

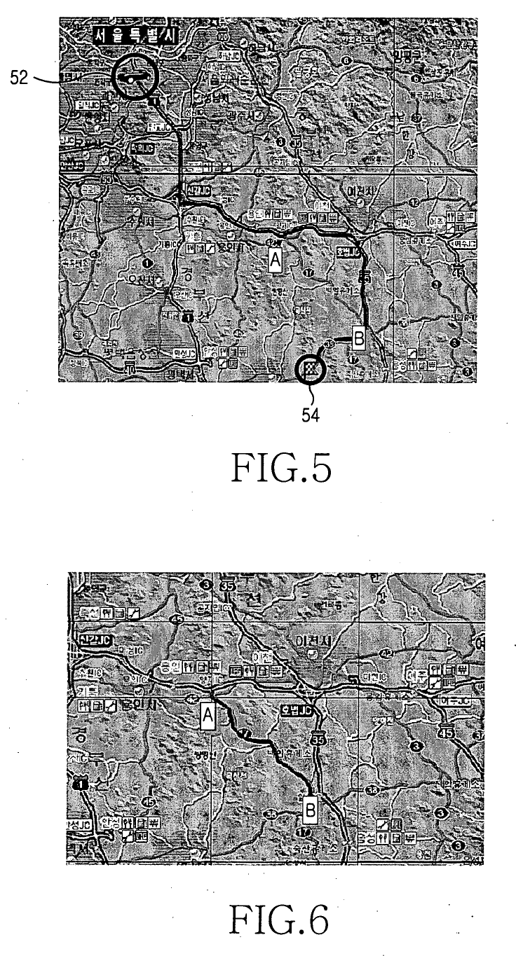

FIG. 5 illustrates an example of a map image according to the first embodiment of the present invention. Reference numeral 52 represents a start point, and reference numeral 54 represents an end point. FIG. 5 illustrates a case in which a path to the end point from the start point is found by wholly applying an option of “Expressway preference” to the path.

In step 408, the path finding apparatus receives a desired section selected by a user from the found entire path according to the option of the “Expressway preference” described above. In other words, the path finding apparatus receives a section undergoing an option change, which is selected by a user from the entire path, like the section A to B.

In step 410, the path finding apparatus selects a sectional path option for the selected section. In other words, the path finding apparatus selects an option of “Expressway preference” applied to the entire path and a sectional path option to be applied to the additionally selected section A to B according to an option selection signal of the user.

In step 412, the path finding apparatus re-finds a path of the selected section according to the sectional path option. FIG. 6 illustrates an example of a map image showing a re-found path for a specific section selected by the user from the entire path according to the first embodiment of the present invention. In other words, FIG. 6 illustrates a result re-found in such a manner that a path for the section A to B selected by the user becomes a state or federal road, hereinafter referred to as a “national road”. Referring to FIG. 6, when the sectional path option to be applied to the section A to B is selected as an option of “National road preference”, the path finding apparatus re-finds the path for the section A to B as shown in FIG. 6 by employing the option of the “National road preference”.

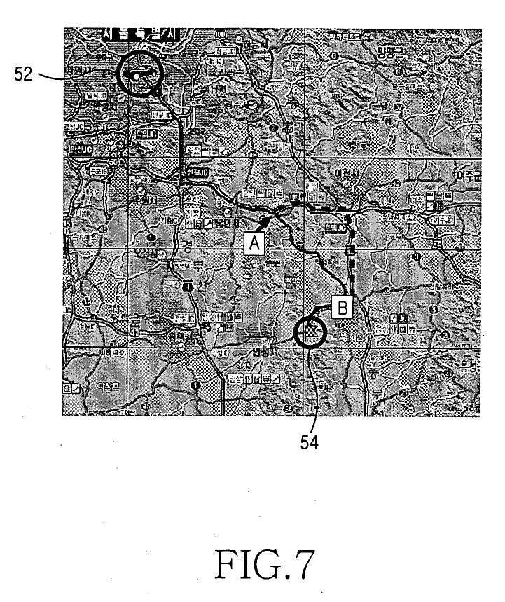

In step 414, the path finding apparatus finds an entire path by replacing the path of the selected partial section with the re-found path. FIG. 7 is a view illustrating an entire path found according to the first embodiment of the present invention. The path finding apparatus finds an entire path to the end point 54 from the start point 52 by replacing the path of the section A to B with a sectional path re-found by employing the option of a “National road preference”.

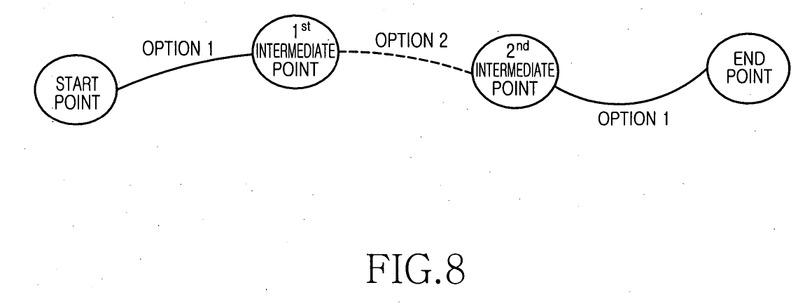

Hereinafter, a description about the concept of the path finding method according to a second embodiment of the present invention will be given. According to the second embodiment of the present invention, the path finding apparatus receives an entire path option to be applied to an entire section and a sectional path option for a specific section, thereby finding a path for each section and an entire path using each found sectional path. FIG. 8 is a view of the concept of the path finding method according to the second embodiment of the present invention. The path finding apparatus registers a start point, an end point, and intermediate points (e.g., a first intermediate point and a second intermediate point) and selects an entire path option (e.g., “Option 1”) for the entire path to the end point from the start point.

Then, the path finding apparatus selects an option (e.g., “Option 2”) for each specific section (e.g., a section between the first intermediate point and the second intermediate point). After selecting the entire path option and the path option for each section as described above, the path finding apparatus finds paths by employing the entire path option and the path option for each section and finds an entire path using the found paths.

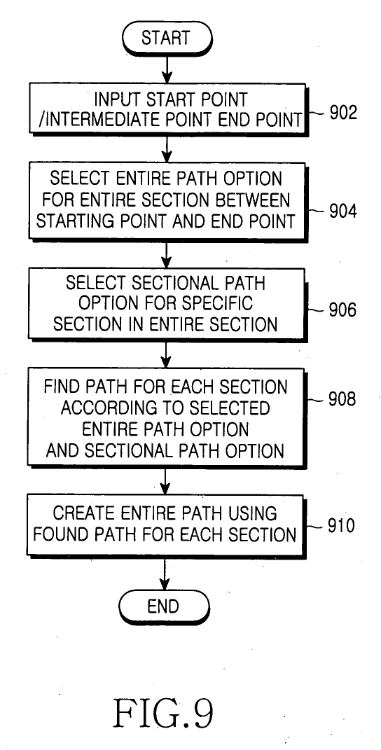

Hereinafter, more detailed description about a procedure of finding a path according to the second embodiment of the present invention as described above will be given with reference to the flow chart of FIG. 9. In step 902, the path finding apparatus receives a start point, an intermediate point, and an end point. The path finding apparatus may receive at least one intermediate point between the start point and the end point. The start point may be input by a user through the user interface unit 206, and may be a current point measured by the sensor unit 204.

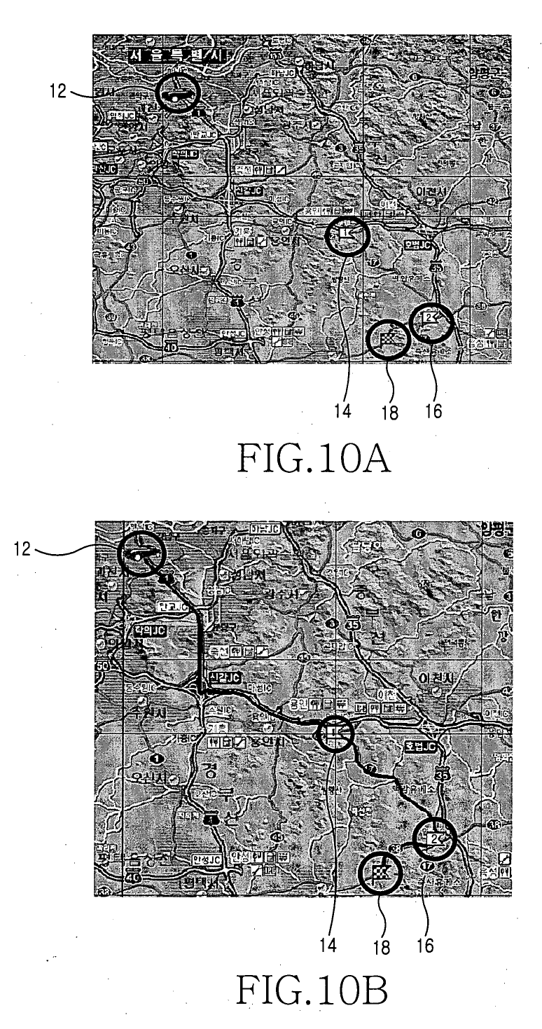

The start point, the intermediate points, and the end point input as described above may be displayed on a map image through the path displaying unit 212. FIGS. 10(A) and 10(B) illustrate examples of the map image according to the second embodiment of the present invention. The start point, the intermediate point, and the end point are displayed on corresponding positions of the map image, respectively as shown in FIG. 10(A). Reference numeral 12 on the left upper part of FIG. 10(A) represents the start point, and reference numeral 14 represents the first intermediate point. Reference numeral 16 represents the second intermediate point, and reference numeral 18 represents the end point. A user can predict a path to the end point 18 from the start point 12 via the first intermediate point 14 and the second intermediate point 16 through the map screen image as shown in FIG. 10(A). In addition, the user can select an entire path option for an entire path to the end point 18 from the start point 12 and a sectional path option for a specific section of the entire path.

If the entire path option is selected by the user, the path finding apparatus selects an entire path option to be applied to an entire path when finding the entire path to the end point from the start point according to the user selection in step 904. In addition, if the sectional path option is selected by the user, the path finding apparatus selects a sectional path option to be applied to a specific section in an entire section between the start point and the end point according to the user selection in step 906. For example, the path finding apparatus may select different sectional path options to be applied to a section between the start point 12 and the intermediate point 14, a section between the first intermediate point 14 and the second intermediate point 16, and a section between the second intermediate point 16 and the end point 18, respectively, as shown in FIG. 10(A) according to the user demand.

After the entire path option for the entire path and each sectional path option for each section are selected as described above, the path finding apparatus finds each path in each section according to the selected entire path option and the selected sectional path options in step 908. In other words, the path finding apparatus finds a path according to a sectional path option with respect to a specific section and paths according to the entire path option with respect to remaining sections excluding the specific section. For example, if the entire path option for the entire path to the end point 18 from the start point 12 is selected as the option of “Expressway preference”, and if the sectional path option for the specific section between the first intermediate point 14 and the second intermediate point 16 on the entire path is selected as the option of “National road preference” in FIG. 10 (A), the path finding apparatus finds paths according to sections by employing the option of “National road preference” for the specific section between the first intermediate point 14 and the second intermediate point 16 and the option of “Expressway preference” for a section between the start point 12 and the first intermediate point 14 and a section between the second intermediate point 16 and the end point 18.

In step 910, the path finding apparatus finds an entire path using paths according to sections in step 910. For example, the path finding apparatus finds an entire path by linking a sectional path between the start point 12 and the first intermediate point 14, a sectional path between the first intermediate point 14 and the second intermediate point 16, and a sectional path between the second intermediate point 16 and the ending point 18 with each other as shown in FIG. 10(A).

As described above, according to the present invention, a sectional path option different from an entire path operation for an entire path is applied to a specific section desired by a user on an entire path to an end point from a start point, so that it is possible to efficiently apply an option desired by the user to path finding.

In addition, it is possible to efficiently satisfy the demand of a user who wants to receive the guidance for a path obtained by applying a different option to a predetermined section of an entire path to an end point.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A method for finding a path in a navigation system, the method comprising the steps of:
selecting a sectional path option for a specific section selected by a user from an entire section between a start point and an end point; and
finding a path in the specific section according to the sectional path option and creating an entire path for an entire section by employing the path in the specific section.

2. The method as claimed in claim 1, wherein the step of selecting the sectional path option comprises the steps of:
selecting an entire path option for the entire section between the start point and the end point;
finding the entire path between the staring point and the end point using the entire path option; and
selecting the specific section desired by a user from the found entire path and selecting the sectional path option for the selected specific section.

3. The method as claimed in claim 2, wherein the step of creating the entire path for the entire section by employing the path in the specific section comprises the steps of:
re-finding a path for the specific section in the entire section by employing the selected sectional path option; and
creating the entire path by replacing the path for the specific section in the entire section with the re-found path for the specific section.

4. The method as claimed in claim 1, wherein the step of selecting the sectional path option comprises the steps of:
selecting the entire path option for the entire section between the start point and the end point; and
selecting the sectional path option for the specific section desired by the user in the entire section.

5. The method as claimed in claim 4, wherein the step of creating the entire path for the entire section by employing the path in the specific section comprises the steps of:
finding a path for each section according to the entire path option and the sectional path option; and
creating the entire path by using the found path of each section.

6. A method for finding a path in a navigation system, the method comprising the steps of:
finding an entire path using an entire path option for an entire section between a start point and an end point;
selecting a specific section desired by a user on the found entire path;
selecting a sectional path option for the selected specific section according to user demand;
re-finding a path for the specific section by employing the selected sectional path option; and
creating the entire path by replacing a path for the specific section on the entire path with the re-found path for the specific section.

7. The method as claimed in claim 6, further comprising displaying the found entire path using the entire path option and receiving the desired specific section from a user on the displayed entire path.

8. A method for finding a path in a navigation system, the method comprising the steps of:
selecting an entire path option for an entire section between a start point and an end point;
selecting a sectional path option for a specific section in the entire section;
finding a path for each section according to the entire path option and the sectional path option; and
creating an entire path using the found path for each section.

9. The method as claimed in claim 8, wherein the step of selecting the entire path option comprises the steps of:
receiving the start point, the end point, and at least one intermediate point between the start point and the end point; and
selecting the entire path option to be applied when finding paths for intermediate points between the start point and the end point.

10. The method as claimed in claim 9, wherein the step of selecting the sectional path option comprises selecting sectional path options to be applied to a section between the start point and a first intermediate point, a section between intermediate points, and a section between a last intermediate point and the end point.

11. The method as claimed in claim 8, wherein the step of finding a path for each section according to the entire path option and the sectional path option comprises finding a sectional path according to each section option with respect to the specific section and paths according to the entire path option with respect to remaining sections excluding the specific section.
